(19) United States
(12) Patent Application Publication
(10) Pub. No.: US 2010/0293507 A1
(43) Pub. Date: Nov. 18, 2010

(54) METHOD AND SYSTEM FOR CREATING REPORT USING OBJECT-ORIENTED PROGRAM

(75) Inventors: Dae Gwan Song, Seoul (KR); Jae Yool Shin, Anyang-city Gyeonggi-do (KR); Kyoung Sik Choi, Suwon-city Gyeonggi-do (KR)

Correspondence Address: PROCOPIO, CORY, HARGREAVES & SAVITCH LLP, 525 B STREET, SUITE 2200, SAN DIEGO, CA, 92101, US

(73) Assignee: EYEQ MC CO., LTD., Seoul, KR (KR)

(21) Appl. No.: 12/679,867

(22) PCT Filed: Sep. 25, 2008
(86) PCT No.: PCT/KR08/05679

§ 371 Date: Jul. 7, 2010

(30) Foreign Application Priority Data
Sep. 27, 2007 (KR) 10-2007-0097385

(51) Int. Cl. G06F 17/30; G06F 3/048

(52) U.S. Cl. 715/810; 707/769; 707/E17.014

(57) ABSTRACT

Provided is a method and system for creating a report by using objects, the method includes: receiving input information including a first table that includes data that is to be output from among a plurality of tables stored in a database and properties of the data; generating a query language sentence used to extract the data from the first table according to the input information; extracting the data from the first data by using the query language sentence; receiving diagram selection information in which a type of diagram for presenting the extracted data is selected; establishing details of the selected type of diagram so as to present the extracted data; generating output objects presenting the extracted data as the selected type of diagram by using the diagram selection information and the established details; designating locations where the output objects are arranged in a report that is to output the output objects; and generating a report screen including the output objects arranged in the locations designated in the report.

### TECHNICAL FIELD

This application claims the benefit of Korean Patent Application No. 10-2007-0097385, filed on Sep. 27, 2007, in the Korean Intellectual Property Office, the disclosure of which is incorporated herein in its entirety by reference.

The present invention relates to a method and system for automatically creating a report using an object, and a method and system for automatically generating a report screen by selecting a table that stores data that is to be output by a user and selecting a property of the table, selecting a diagram for presenting the data, establishing details of the chart, and inputting information designating the location of the chart.

### BACKGROUND ART

There is a need for an efficient executive information system (EIS) in order to manage and utilize data relating to enterprises with regard to business administration.

The EIS is a computer based information system for effectively providing information regarding the internal or external activities of companies, which is required by executives or CEOs of companies.

In more detail, the EIS refers to a system designed to collect, transfer, process, store, and use information regarding the internal or external activities of companies spontaneously and in large quantities in order to increase validity of decisions in regard to the administration of companies.

In particular, it becomes more important to extract a key performance indicator that is linked with the administration of companies from a plurality of pieces of data relating to the internal or environment of companies, preparing a report regarding the key performance indicator, and building an Internet portal website for providing companies' owners with the report.

When a company is comprised of several departments, a department based decision support database that stores data collected in each department refers to a data mart. A plurality of data marts forms a data warehouse that stores detailed data regarding the whole company.

Online analytical processing (OLAP) refers to an analytical application that supports inquires requiring mass-operation at high speed in order for a user to search for and analyze the data warehouse. In more detail, the OLAP corresponds to a tool for converting data that is collected and stored in the data warehouse into strategic information.

The data included in the data warehouse is generally processed as information, such as the key performance indicator, by using the OLAP, and is output in a report. In this case, a visually effective diagram, such as a chart or grid, is used to present information in a report in order to facilitate easy understanding of the administration status of companies and increase a user's intuitive analytical ability.

A main portal has a login function for authorizing users and a menu system for accessing an administration information report, and provides users with discriminate authorization for accessing the administration information report. If a menu with user access authorization is selected, an item linked with the administration information report is presented, and, if the item is selected, a report screen is output.

In a conventional report creating system, users program all screen structures and functions of portals and reports. In more detail, users conventionally use a simple application development program to present layouts of reports and portal screens, and program the logic of events necessary for each portal screen to form reports and portals.

An EIS dedicated development system has been suggested to form reports and portal screens, which is a specialized development tool having a diagramming function for presenting information by using a diagram, such as a chart or a grid, suitable for displaying a report screen of the EIS in the simple application development program used in the conventional report creating system.

Although the conventional EIS dedicated development system is slightly more advantageous to users compared to other conventional technologies, users have to program the logic of events necessary for reports or portal screens personally, or divide a screen element including data into several layers to display the data.

Thus, the conventional EIS dedicated development system has required a user's programming ability with regard to various fields in order to conduct a project for reporting the status of the key performance indicator in the EIS.

For example, a programming ability in the use of a structured query language (SQL) or a multidimensional expression (MDX) query language is required to extract desired data, and a programming ability in the use of a Java server page (JSP), an active server page (ASP), JAVA SCRIPT, or ACTION SCRIPT, etc, is required to realize a screen that outputs the extracted data.

Therefore, users who lack this programming knowledge have difficulties in creating reports. Furthermore, although users having this programming knowledge can create reports, it takes much time and cost to conduct the programming.

Also, since report screens are programmed to present information or data in a screen unit or are constructed as multistage layers, users other than a person who has generated a report screen have difficulties in understanding or analyzing the structure and logic of the report screen.

Therefore, it is cumbersome to change or correct a previously prepared report, and it not easy for another user to correct or edit the previously prepared report, making it difficult to distribute, change or reuse the previously prepared report.

### DISCLOSURE OF INVENTION

### Technical Solution

The present invention provides a method and system for creating a report by inputting a table storing data that is to be output by a user and inputting the property of the table, selecting a diagram used to output the data, automatically generating output objects, and arranging the output objects.

### Advantageous Effects

According to the present invention, when a simple piece of information is input, since a query language sentence is automatically generated, a person who creates a report or a user can search for and extract desired material from a database and use the material in the report even if the person or user lack programming knowledge, by using a query language.

Also, a report relating to an E IS is created based on an object-oriented thought in view of output objects, other than a screen programming centered thought.

In more detail, since output objects are only arranged when the report is created, programming that uses the query language sentence is unnecessary, and given output objects are arranged in a new report when the new report is created, thereby easily distributing and reusing content included in the report by using output objects.

Logic for building a report screen is simple owing to the arrangement of output objects, making it possible to more easily build the report screen. A third party can easily correct or edit content of the report screen for each output object.

Time required to create a report and build a portal is dramatically reduced, and the development, operation, and distribution costs are reduced. It is easy to distribute a material included in the report screen in a company, and costs less to maintain, reconstruct, and distribute data of the company.

### DESCRIPTION OF DRAWINGS

FIG. 1 is a block diagram of a system for creating a report by using objects according to an embodiment of the present invention;

FIG. 2 is a screen for displaying a piece of basic information of one of a plurality of tables stored in a database;

FIG. 3 is a screen for displaying a property of one of the plurality of tables stored in the database;

FIG. 4 is a screen for inputting input information used to generate a query language sentence;

FIG. 5 is a screen for outputting a generated query language sentence;

FIG. 6 is a screen for displaying basic information of generated output objects;

FIGS. 7 through 9 are screens for displaying data presented as diagrams by using output objects;

FIG. 10 is a screen for designating locations where output objects are arranged in a report that is to output the output objects;

FIG. 11 is a generated report screen;

FIG. 12 is a screen for inputting basic information of a portal so as to generate a portal screen;

FIG. 13 is a screen for selecting a template of a portal so as to generate a portal screen;

FIG. 14 is a generated portal screen;

FIG. 15 is a report screen that is displayed by selecting a menu and item in the generated portal screen; and

FIG. 16 is a flowchart illustrating a method of creating a report according to an embodiment of the present invention.

### BEST MODE

According to an aspect of the present invention, there is provided a method of creating a report by using objects, the method comprising: receiving input information including a first table that includes data that is to be output from among a plurality of tables stored in a database and properties of the data; generating a query language sentence used to extract the data from the first table according to the input information; extracting the data from the first data by using the query language sentence; receiving diagram selection information in which a type of diagram for presenting the extracted data is selected; establishing details of the selected type of diagram so as to present the extracted data; generating output objects presenting the extracted data as the selected type of diagram by using the diagram selection information and the established details; designating locations where the output objects are arranged in a report that is to output the output objects; and generating a report screen including the output objects arranged in the locations designated in the report.

The method may further comprise generating a portal screen including menus each having items, wherein, if one of the menus is selected, items of the selected menu are displayed on the portal screen, and if one of the displayed items is selected, the report screen is displayed.

The data may include upper material values, the database may additionally store a second table including lower material values that comprise detailed information regarding the upper material values, the input information may further include information regarding the relationship between the first table and the second table, and if the upper material values included in the data that is presented as the selected type of diagram are selected, the output objects may make it possible to call and output lower output objects that output the lower material values of the second table in a second diagram by using the information regarding the relationship between the first table and the second table.

The input information may further comprise a search condition used to search for data that is to be output by the selected type of diagram according to search data, the output objects may further comprise search objects used to input the search data, and the output objects may search for the data that is to be output by the selected type of diagram by using the search data that is input in the search objects and the search condition, and present the found data as the selected type of diagram by using the diagram selection information and the established details.

According to another aspect of the present invention, there is provided a recording medium having recorded thereon a computer program for executing the above method.

According to another aspect of the present invention, there is provided a system for creating a report by using objects, the system comprising: a database storing a plurality of tables; a means of receiving input information including a first table that includes data that is to be output among the plurality of tables stored in the database and properties of the data; a means of generating a query language sentence used to extract the data from the first table according to the input information; a means of extracting the data from the first table by using the query language sentence; a means of receiving diagram selection information in which a type of diagram for presenting the extracted data is selected; a means of establishing details of the selected type of diagram so as to present the extracted data; a means of generating output objects presenting the extracted data as the selected type of diagram by using the diagram selection information and the established details; a means of designating locations where the output objects are arranged in a report that is to output the output objects; and a means of generating a report screen including the output objects arranged in the locations designated in the report.

The system may further comprises a means of generating a portal screen including menus each having items, wherein, if one of the menus is selected, items of the selected menu are displayed on the portal screen, and if one of the displayed items is selected, the report screen is displayed.

The data may include upper material values, the database may additionally store a second table including lower material values that are detailed information regarding the upper material values, the input information may further include information regarding the relationship between the first table and the second table, and if the upper material values included in the data that is presented as the selected type of diagram are selected, the output objects may make it possible to call and output lower output objects that output the lower material values of the second table in a second diagram by using the information regarding the relationship between the first table and the second table.

The input information may further include a search condition used to search for data that is to be output by the selected type of diagram according to search data, the output objects may further include search objects used to input the search data, and the output objects may search for the data that is to be output by the selected type of diagram by using the search data that is input in the search objects and the search condition, and present the found data as the selected type of diagram by using the diagram selection information and the established details.

### MODE FOR INVENTION

Hereinafter, the present invention will be described in detail by explaining preferred embodiments of the invention with reference to the attached drawings.

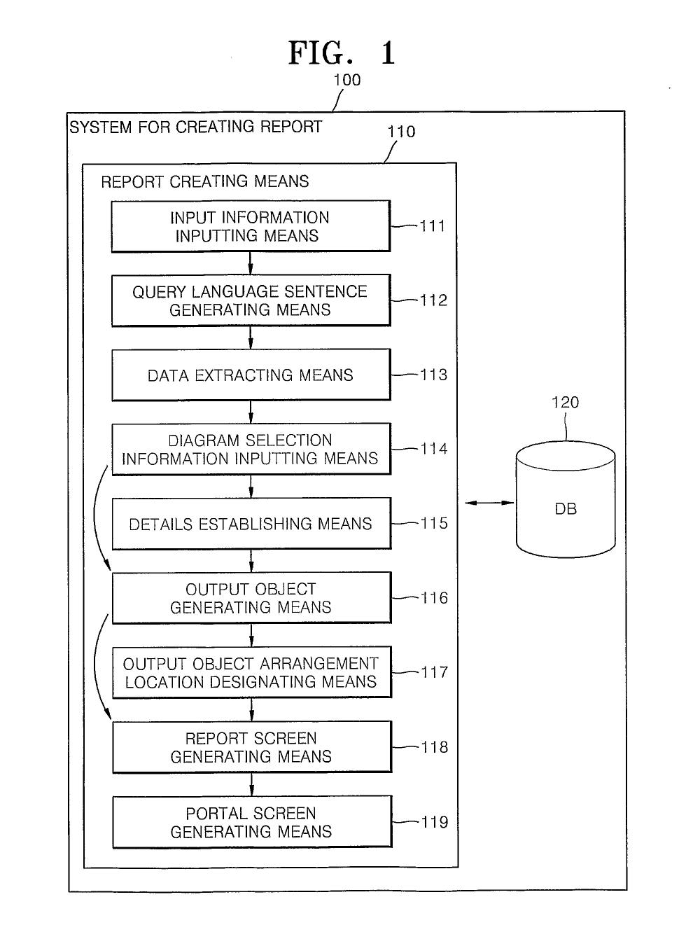

FIG. 1 is a block diagram of a system 100 for creating a report by using objects according to an embodiment of the present invention. Referring to FIG. 1, the system 100 for creating the report comprises a report creating means 110 and a database 120. The report creating means 110 comprises an input information inputting means 111, a query language sentence generating means 112, a data extracting means 113, a diagram selection information inputting means 114, a details establishing means 115, an output object generating means 116, an output object arrangement location designating means 117, a report screen generating means 118, and a portal screen generating means 119.

The database 120 refers to a general storage means that stores one or more tables in which various pieces of data are recorded.

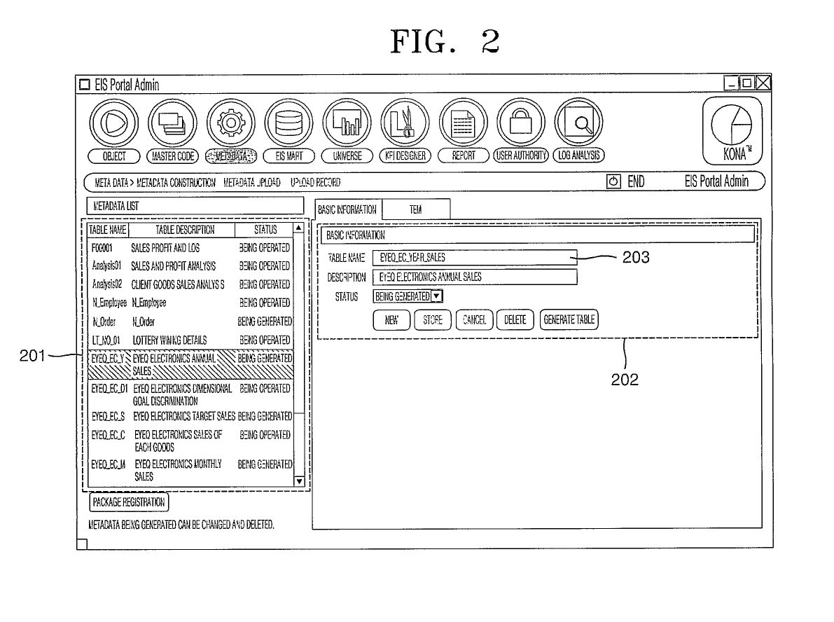

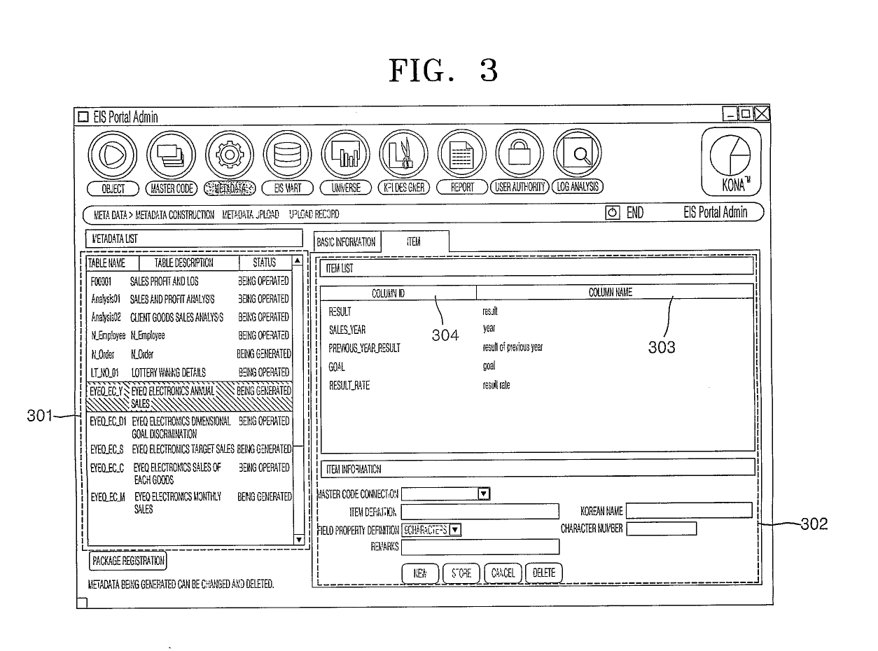

FIG. 2 is a screen for displaying a piece of basic information of one of a plurality of tables stored in the database 120. FIG. 3 is a screen for displaying a property of one of the plurality of tables stored in the database 120.

Referring to FIG. 2, a table EYEQ_EC_Y that is selected from a list 201 of tables stored in the database 120 is displayed in black on the left of the screen. A table name 203 of the selected table EYEQ_EC_Y included in the basic information 202 is displayed on the right of the screen.

Referring to FIG. 3, a table EYEQ_EC_Y that is selected from a list 301 of tables stored in the database 120 is displayed in black on the left of the screen. A column name 303 and a column ID 304 that, respectively, are a name and ID information of a column included in the selected table EYEQ_EC_Y included in an item list 302 are displayed on the right of the screen.

Properties of data included in the selected table EYEQ_EC_Y are indicated as columns with reference to FIG. 3. For example, when data having a result rate of 95% in 2006 is included in the selected table EYEQ_EC_Y, a material value corresponding to a column ‘year’ (property: SALES_YEAR) is 2006, and a material value corresponding to a column ‘result rate’ (property: RESULT_RATE) is 95%.

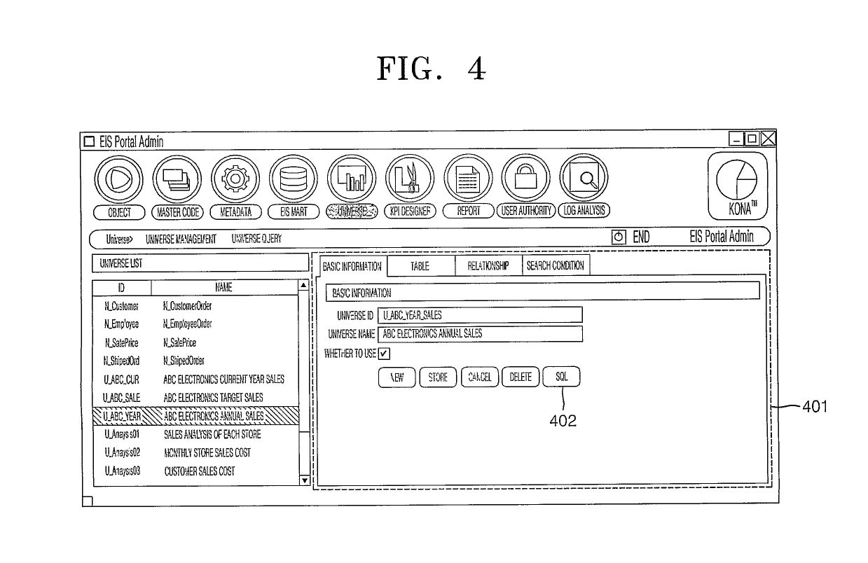

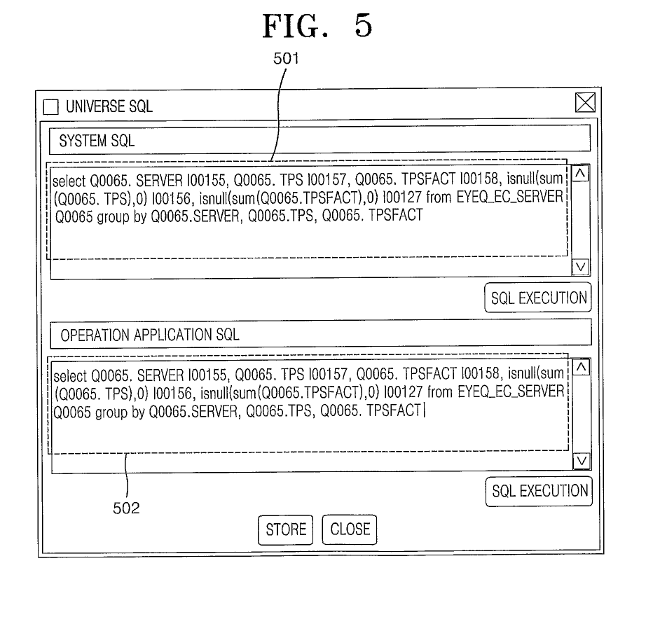

FIG. 4 is a screen for inputting input information used to generate a query language sentence. FIG. 5 is a screen for outputting the generated query language sentence.

The input information inputting means 111 receives the input information through an input information inputting unit 401 on the right of the screen shown in FIG. 4. The input information includes a first table including data that is to be output and the property of the data that is to be output.

The first table including the data that is to be output and that is included in the input information is a first table including the data that is to be output in a report among the tables stored in the database 120. For example, the information inputting means 111 can receive input information including information for selecting the first table from the tables stored in the database 120 through an input information inputting unit 401.

The property of the data that is to be output and that is included in the input information is a property (column) of the first table designated for selecting the data that is to be output from data included in the first table.

The input information received by the input information inputting means 111 can include information regarding the relationships between a plurality of tables.

A second table that includes lower material values that are detailed information regarding an upper material value that is included in the data included in the first table can be additionally stored in the database 120. In this case, the input information received by the input information inputting unit 401 can further include information regarding the relationship between the first and second tables.

For example, the first table, which concerns annual sales of a company, has properties, such as year, annual sales, etc. The second table, which concerns monthly sales of the company, has properties, such as year, year/month, and monthly sales, etc. In more detail, if the company records sales of one hundred million won in August of 2007, a record of 2007/200708/100,000,000 can be input in the second table in the order of year, year/month, and monthly sales.

If a year is set as a primary key in the first table, a year/month is set as a primary key and a year is set as a foreign key in the second table, the relationship in which the annual sales of the first table is the upper material value and the monthly sales of the second table is the lower material values can be set between the first and second tables by the medium of a value of the year.

The input information received by the input information inputting means 111 through the input information inputting unit 401 includes a search condition. The search condition refers to a condition used to search for data that is to be output as diagrams by using search data. The search data refers to values input by a user through search objects.

For example, the first table, which concerns monthly sales of a company, has properties, such as year, year/month, and monthly sales, etc. If search data input by the user through search objects is the same as material values of the property ‘year’ included in the first table, the search condition can be a condition used to search for data regarding annual sales of the ‘year’. The search objects will be described later in more detail.

The query language sentence generating means 112 generates a query language sentence that is used to extract the data that is to be output from the first table according to the input information received by the input information inputting means 111.

The query language sentence, which is used to extract data that is to be output from a plurality of tables in the database 120, can include a structured query language (SQL) or a multidimensional expression (MDX) query, etc. Hereinafter, the SQL, which is a representative query language, will be described.

The query language sentence generating means 112 previously programs query language sentences used to extract data in a predicted status, stores the programmed query language sentences in the database 120, if the user actually inputs the input information, calls one of the programmed query language sentences from the database 120, adds a name of the first table and a name of a selected property to the called query language sentence, and generates a query language sentence desired by the user.

For example, if the query language sentence is an SQL sentence, the first table, which concerns monthly sales of a company, has properties, such as year, year/month, and monthly sales, etc. In this case, in order to output data of monthly sales in 2007, the input information received by the input information inputting means 111 includes the first table and a property of year ‘2007 ’. The query language sentence generating means 112 can generate an SQL sentence ‘SELECT * FROM first table WHERE year=‘2007’; ’.

If an SQL button 402 is selected by using a mouse after the input information is input through the input information inputting unit 401 as shown in FIG. 4, the query language sentence generated by the query language sentence generating means 112 is output as shown in FIG. 5.

The user can correct the query language sentence generated by the query language sentence generating means 112 personally. Referring to FIG. 5, the query language sentence generated by the query language sentence generating means 112 is a system SQL 501, and a query language sentence corrected by the user is an operation application SQL 502.

In the present embodiment, if simple input information is input, a query language sentence, such as an SQL sentence, is automatically generated, even if a person who prepares a report or a user lacks programming knowledge, by using a query language, and thus it is possible to search for and extract desired material from a database and use the material to prepare the report.

Also, in the present embodiment, since it is possible to correct the generated query language sentence, an experienced programmer can correct the query language sentence in accordance with his/her own preference and prepare the report.

The data extracting means 113 extracts the data that is to be output in the first table by using the query language sentence generated by the query language sentence generating means 112.

The diagram selection information inputting means 114 receives diagram selection information in which a type of a diagram for presenting the data output by the data extracting means 113 is selected. Various types of diagrams may be stored in the database 120. The diagram selection information is information in which one of various types of diagrams stored in the database 120 is selected.

If the type of the diagram for presenting the data is selected, the details establishing means 115 establishes details of the selected type of diagram in order to present the extracted data in the selected type of diagram.

The details refer to established presentation properties of a diagram with regard to detailed parts of the diagram in order to precisely and efficiently present data. For example, if the selected type of the diagram is a bar graph or a broken line graph, a color or a numerical value of a horizontal axis or a vertical axis can be details.

The output object generating means 116 generates output objects that output the data extracted by the data extracting means 113 as a diagram by using the diagram selection information received by the diagram selection information inputting means 114 and the details established by the details establishing means 115.

For example, the output object generating means 116 generates output objects that present the data as the height of bars of a bar graph or points of a broken line graph by inputting numeral values of the data in the selected type of diagram. Also, the output object generating means 116 generates output objects, in which a name of each axis or an interval indicating the data in each axis is modified, in a basic diagram that is stored in the database 120 by inputting the established details in the selected type of diagram.

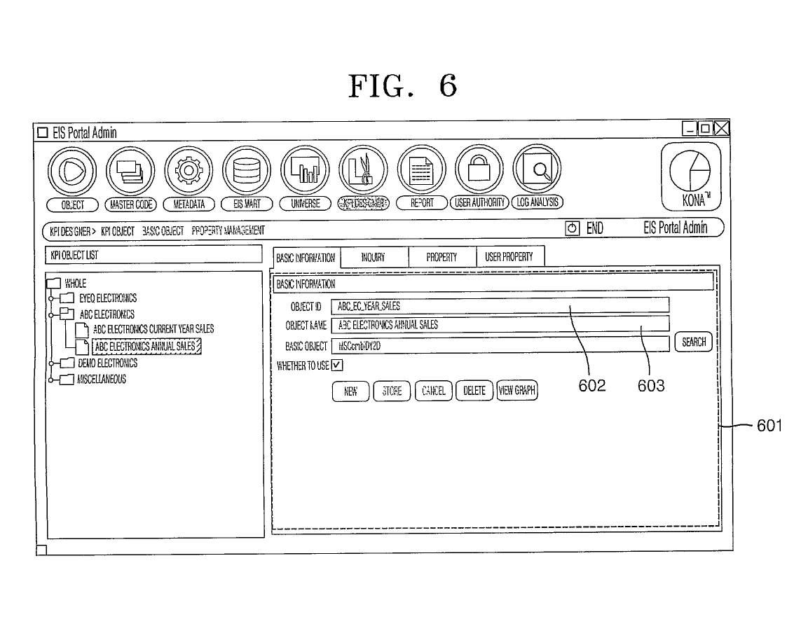

FIG. 6 is a screen for displaying basic information of generated output objects. Referring to FIG. 6, a basic information outputting unit 601 includes a part 602 that displays object IDs that are ID information of output objects and a part 603 that displays object names that are names of the output objects.

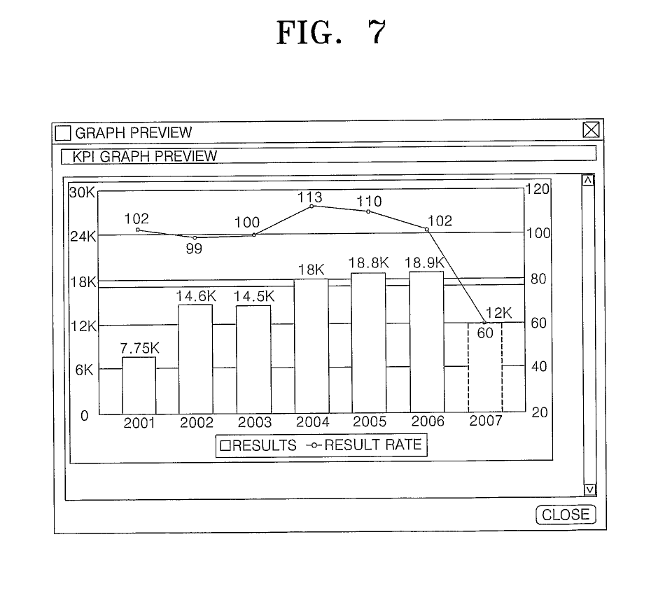

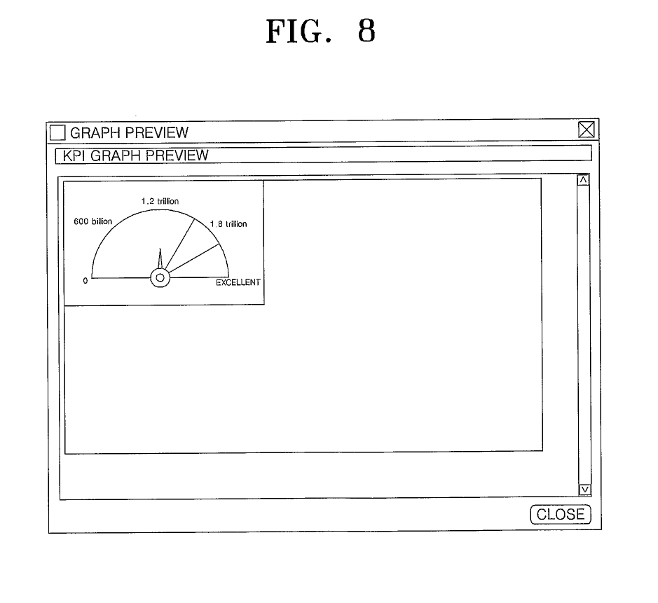

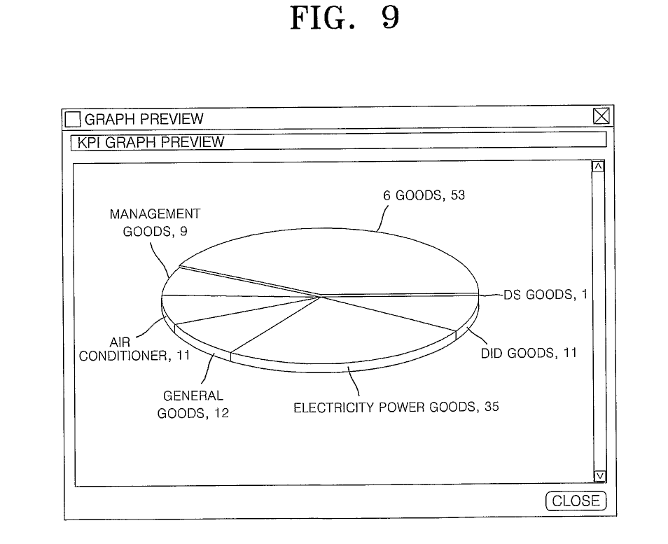

The output objects refer to the presentation of data that is extracted by using a query language sentence and is combined with visual elements, such as diagrams. FIGS. 7 through 9 are screens for displaying data presented as diagrams by using the output objects.

If each of upper material values presented as diagrams in the output objects is selected by using a mouse, the output objects make it possible to call and output lower output objects that present lower material values presenting detailed information regarding each upper material value. Outputting of the lower material values that are detailed information regarding the upper material values that are more comprehensive than the lower material values while outputting the upper material values is referred to as a drill-down.

To the contrary, if a button included in lower objects or a button within a report screen including the lower objects is selected by using the mouse, lower output objects that output lower material values make it possible to output upper output objects presenting upper material values with regard to the lower material values. Outputting of the upper material values that are more comprehensive than the lower material values while outputting the lower material values that are detailed information regarding the upper material values is referred to as a drill-up.

When the second table that includes the lower material values that are detailed information regarding the upper material values that are included in the data of the first table is additionally stored in the database 120, and the input information further includes information regarding the relationship between the first and second tables, if the upper material values that are included in the data of the first table and that are presented as diagrams are selected, the output objects make it possible to call and output the lower output objects that output the lower material values of the second table in a second diagram by using the information regarding the relationship between the first and second tables.

For example, if the first table concerns annual sales, and the second table concerns monthly sales, the first table includes data regarding annual sales results and a result rate with respect to target results, the annual sales results are upper material values, and monthly sales of a year corresponding to the annual sale results are lower material values.

Referring to FIG. 7, the output objects present the first table as a diagram in which the annual sales results of the first table are presented as bar graphs, and the result rate with respect to target results is presented as a broken line graph. The lower output objects output the lower material values of the second table in the second diagram in which the monthly sales that are the lower material values are presented as bar graphs in the same manner as the output objects of FIG. 7.

If one of bar graphs presenting the annual sales results that are the upper material values is selected, the output objects make it possible to call the lower output objects with regard to the monthly sales of a year corresponding to the selected bar graph and output the monthly sales that are the lower material values of the second table in the second diagram.

Also, if the lower output objects include a drill-up button, and the drill-up button is selected by using the mouse, the output objects regarding the annual sales results may be called and output.

The output objects further include search objects used to input search data, search for data that is to be output by using the output objects based on the search data that is input into the search objects and search condition included in the input information, and present the found data as diagrams based on the diagram selection information and the established details.

The search objects are included in the output objects and are used to input the search data. In order to input the search data, the search objects can be realized by the user via a keyboard, or are used to input one item of given exemplary search data that is selected by the user.

The search data and the search condition are the same as described above. That is, the output objects previously generate and store predicted search result values, and, if search data that is input via the output objects is identical to one of predicted search result values, present data corresponding to the input search data as diagrams.

For example, the first table, which concerns monthly sales of a company, has properties, such as year, year/month, and monthly sales, etc., and the search condition is that data regarding monthly sales of a year that is the same as a material value of the property ‘year’ included in the first table is searched.

In this case, if a value of the search data that is input via the search objects included in the output objects is 2006, the output objects may search for data regarding monthly sales in 2006 in the first table and present the data as diagrams.

The output object arrangement location designating means 117 designates locations where the output objects generated by the output object generating means 116 are arranged in a report that is to output the output objects.

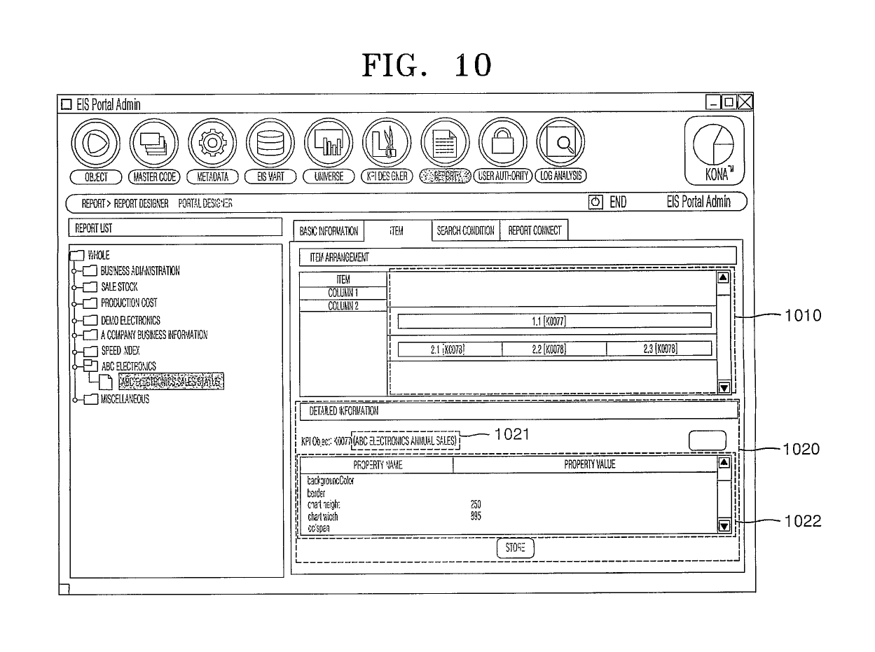

FIG. 10 is a screen for designating locations where output objects are arranged in a report that is to output the output objects by using the output object arrangement location designating means 117. Referring to FIG. 10, a presentation object arranging unit 1010 approximately displays the locations of the output objects that are arranged in the report. ‘1.1[K0077]’ is in a bold line, which indicates that ‘1.1[K0077]’ is selected.

An output object naming unit 1021 included in a detailed information unit 1020 displays a name of an output object [K0077] that is arranged in ‘1.1’ selected by the presentation object arranging unit 1010. An output object information displaying unit 1022 included in the detailed information unit 1020 displays a name and value of property of the output object [K0077] that is to be output.

The report screen generating means 118 generates a report screen including the output objects that are arranged in the locations designated by the output object arrangement location designating means 117 in the report that is to output the output objects generated by the output object generating means 116.

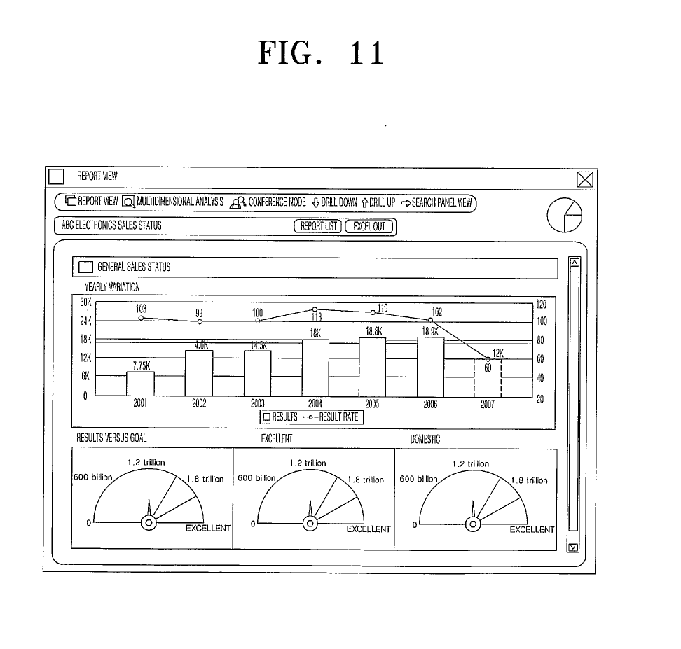

FIG. 11 is a generated report screen. Referring to FIG. 11, the report screen displays the output objects that are arranged in the designated locations shown in FIG. 10. As approximately displayed in the presentation object arranging unit 1010 shown in FIG. 10, one of four output objects is placed in a row, and the other three output objects are arranged in two rows.

In the present embodiment, a report relating to an efficient executive information system (EIS) is prepared based on an object-oriented thought in view of output objects, other than a screen programming centered thought.

In more detail, since output objects are only arranged when the report is created, programming that uses the query language sentence is unnecessary, and given output objects are arranged in a new report when the new report is created, thereby easily distributing and reusing content included in the report by using output objects.

Logic for building a report screen is simple owing to the arrangement of output objects, making it possible to more easily build the report screen. A third party can easily correct or edit content of the report screen for each output object.

The portal screen generating means 119 generates a portal screen including menus each having items. If a menu is selected, items of each menu are displayed on the portal screen. If one of the output items is selected, a report screen corresponding to the selected item is displayed.

A portal includes an Internet website that is a first page of a web browser and a portal for performing necessary jobs including distributed computing systems and administrative information of a company as a personalized single screen. Also, the portal includes Internet and Intranet portals.

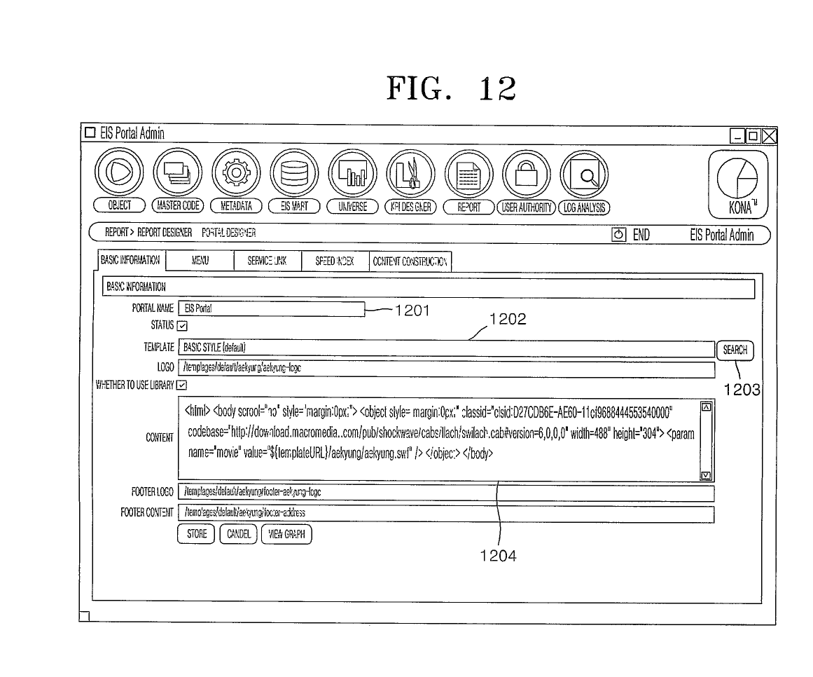

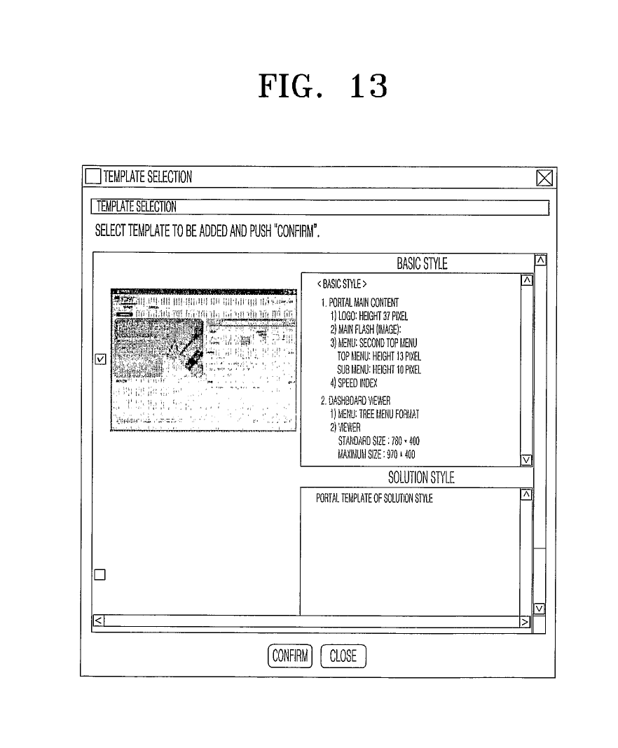

FIG. 12 is a screen for inputting basic information of a portal so as to generate a portal screen. FIG. 13 is a screen for selecting a template of the portal so as to generate the portal screen.

Referring to FIG. 12, a portal naming unit 1201 receives a name of the portal.

If a template searching unit 1203 is selected by using a mouse, referring to FIG. 13, a window for selecting a template of the portal is newly generated, and one of a plurality of types of templates of the portal that are stored in the database 120 is selected. A template selecting unit 1202 displays the selected type of template. A portable screen constructing unit 1204 presents a basic construction of the selected type of the portal screen in a hypertext markup language (HTML).

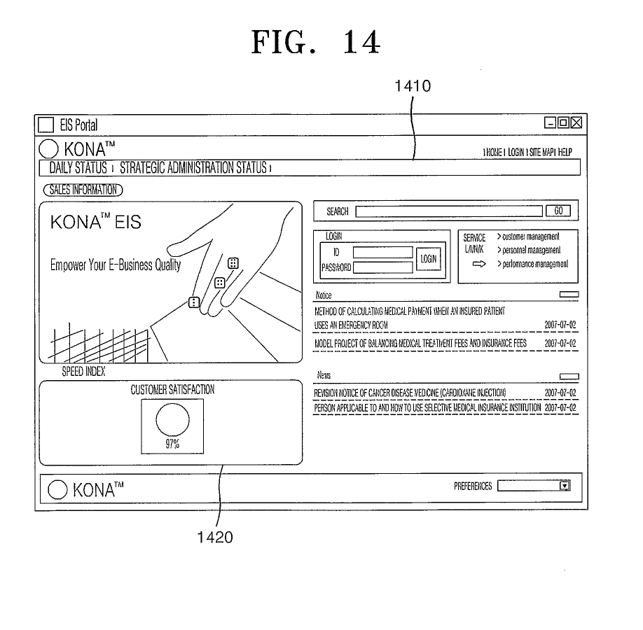

FIG. 14 is a portal screen generated by the portal screen generating means 119. Referring to 14, the portal screen includes a menu unit 1410 and a key indicator approximate displaying unit 1420. The key indicator approximate displaying unit 1420 outputs output objects presenting data that is assumed to be important as diagrams and displays the data.

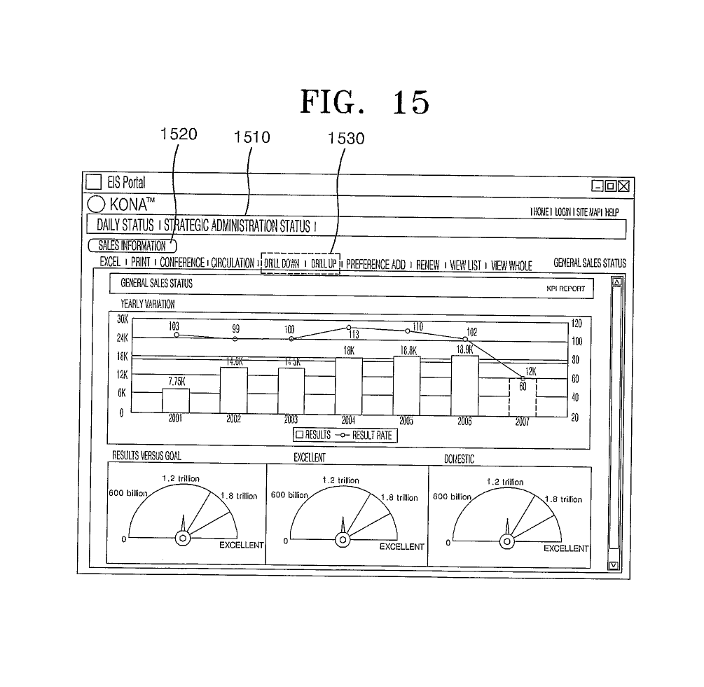

FIG. 15 is a report screen that is displayed by selecting a menu and item in the generated portal screen. Referring to FIG. 15, if one of two menus included in a menu unit 1510 is selected, an item 1520 that is sales information is displayed. If the displayed item 1520 is selected, the report screen corresponding to the selected item is displayed on a report screen outputting unit 1540.

A drill-down and drill-up unit 1530 provides drill-down and drill-up functions. For example, when one of output objects included in the report screen that is displayed on the report screen outputting unit 1540 is selected, if a lower output object with regard to the selected output object is generated and called, the drill-down function of the drill-down and drill-up unit 1530 may be activated so as to be selected by using a mouse.

In this case, if one of a plurality of material values displayed on the selected output object is selected by using the mouse and the drill-down function of the drill-down and drill-up unit 1530 is selected by using the mouse, a lower output object corresponding to the selected material value is called and output.

Also, if an upper output object corresponding to the lower output object exists, a drill-up function of the drill-down and drill-up unit 1530 may be activated so as to be selected by using the mouse. In this case, if the drill-up function is selected by using the mouse, the upper output object is called and output.

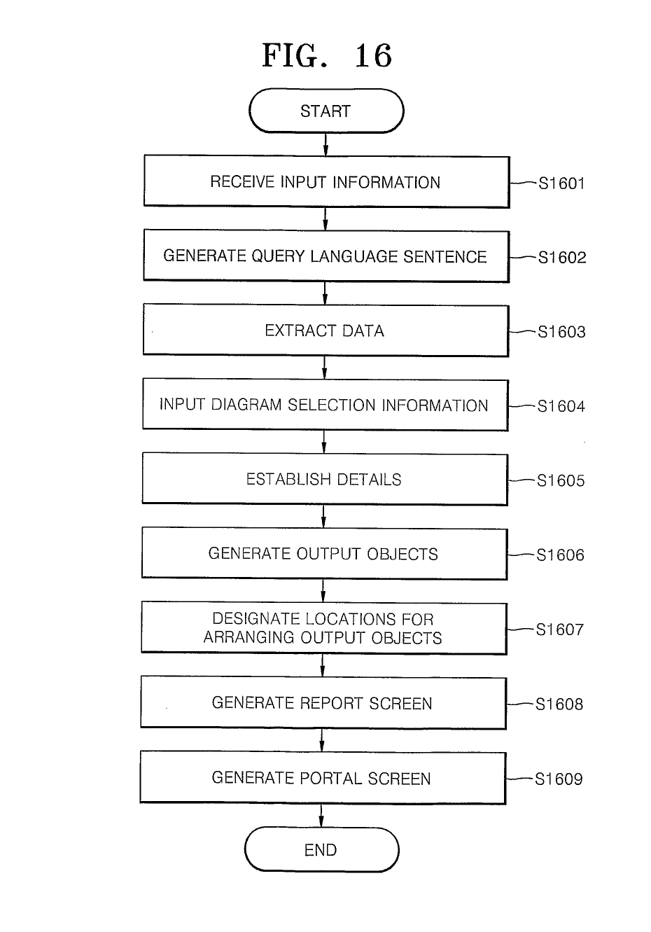

FIG. 16 is a flowchart illustrating a method of creating a report according to an embodiment of the present invention. Referring to FIG. 16, in operation 1601, the input information inputting means 111 receives input information including a first table including data that is to be output from among a plurality of tables stored in the database 120 and properties of the data.

If the data included in the first table includes upper material values and a second table including lower material values that is detailed information with regard to the upper material values is additionally stored in the database 120, the input information may further include information regarding the relationship between the first and second tables.

The input information received by the input information inputting means 111 through the input information inputting unit 401 includes a search condition. The search condition refers to a condition used to search for data that is to be output as diagrams by using search data. The search data refers to values input by a user through search objects.

In operation 1602, the query language generating means 112 generates a query language sentence used to extract the data that is to be output from the first table according to the received input information. As described above, the user can correct the query language sentence generated by the query language generating means 112 personally.

In operation 1603, the data extracting means 113 extracts the data that is to be output in the first table by using the query language sentence generated by the query language sentence generating means 112.

In operation 1604, the diagram selection information inputting means 114 receives diagram selection information in which a type of diagram for outputting the data extracted by the data extracting means 113 is selected. The diagram selection information is information in which one of various types of diagrams stored in the database 120 is selected.

In operation 1605, the details establishing means 115 establishes details of diagrams so that the selected type of diagram can present the data extracted by the data extracting means 113. The details refer to established presentation properties of a diagram with regard to detailed parts of the diagram in order to precisely and efficiently present data.

In operation 1606, the output object generating means 116 generates output objects that present the data extracted by the data extracting means 113 as diagrams by using the diagram selection information and the established details. The output objects refer to presentation of data that is extracted by using a query language sentence and is combined with visual elements, such as diagrams.

When the input information received by the input information inputting means 111 further include the information regarding the relationship between the first and second tables, if the upper materials values included in the data of the first table that is presented as diagrams are selected, the output objects make it possible to call and output lower output objects that output the lower material values of the second table in a second diagram by using the information regarding the first and second tables, by which drill-down and drill-up functions are realized as described above.

Also, the output objects further include search objects used to input search data. The data that is to be output by the output objects is searched for by using the search data that is input in the search objects and the search condition included in the input information, and the found data is presented as diagrams by using the diagram selection information and the established details.

The search objects are included in the output objects and are used to input the search data. The search objects can be realized to input the search data by the user via a keyboard, or to input one of given exemplary search data that is selected by the user.

In operation 1607, the output object arrangement location designating means 117 designates locations where the output objects are arranged in a report that is to output the output objects generated by the output object generating means 116.

In operation 1608, the report screen generating means 118 generates a report screen including the output objects that are arranged in the locations designated in the report.

In operation 1609, the portal screen generating means 119 generates a portable screen including menus each having items. If one of the menus is selected, items included in the selected menu are displayed on the portal screen. If one of the displayed items is selected, the report screen generated by the report screen generating means 118 is displayed on the portal screen. As described above, a portal includes Internet and Intranet portals.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of creating a report by using objects, the method comprising:
receiving input information including a first table that includes data to be output from among a plurality of tables stored in a database and properties of the first data;
generating a query language sentence used to extract the first data from the first table according to the input information;
extracting the first data from the first table using the query language sentence;
receiving diagram selection information used to select a type of diagram for presenting the extracted first data;
establishing details of the selected type of diagram;
generating output objects to present the extracted first data as the selected type of diagram by using the diagram selection information and the established details;
designating locations for the output objects in a report; and
generating a report screen including the output objects arranged in the locations designated in the report.

2. The method of claim 1, further comprising:
generating a portal screen including menus, each menu having a plurality of items,
wherein, when one of the menus is selected, the plurality of items of the selected menu is displayed on the portal screen, and
when one item of the displayed items is selected, the report screen is displayed.

3. The method of claim 1, wherein the first data includes upper material values,
wherein the database additionally stores a second table including lower material values that comprise detailed information regarding the upper material values,
the input information further includes information regarding the relationship between the first table and the second table, and if the upper material values included in the first data that is presented as the selected type of diagram are selected, the output objects to call and output lower output objects that output the lower material values of the second table in a second diagram by using the information regarding the relationship between the first table and the second table.

4. The method of claim 1, wherein the input information further comprises
a search condition used to search for data that is to be output by the selected type of diagram according to search data,
wherein the output objects further comprise search objects used to input the search data, and the output objects search for the data that is to be output by the selected type of diagram by using the search data that is input in the search objects and the search condition, and present the found data as the selected type of diagram by using the diagram selection information and the established detail.

5. (canceled)

6. A system for creating a report by using objects, the system comprising:
a database storing a plurality of tables;
a means of receiving input information including a first table that includes first data that is to be output among the plurality of tables stored in the database and properties of the first data;
a means of generating a query language sentence used to extract the first data from the first table according to the input information;
a means of extracting the first data from the first table by using the query language sentence;
a means of receiving diagram selection information in which a type of diagram for presenting the extracted first data is selected;
a means of establishing details of the selected type of diagram so as to present the extracted first data;
a means of generating output objects presenting the extracted first data as the selected type of diagram by using the diagram selection information and the established details;
a means of designating locations where the output objects are arranged in a report that is to output the output objects; and
a means of generating a report screen including the output objects arranged in the locations designated in the report.

7. The system of claim 6, further comprising:
a means of generating a portal screen including menus each having items,
wherein, if one of the menus is selected, items of the selected menu are displayed on the portal screen, and
if one of the displayed items is selected, the report screen is displayed.

8. The system of claim 6, wherein the first data includes upper material values,
wherein the database additionally stores a second table including lower material values that are detailed information regarding the upper material values,
the input information further includes information regarding the relationship between the first table and the second table, and if the upper material values included in the first data that is presented as the selected type of diagram are selected,
the output objects make it possible to call and output lower output objects that output the lower material values of the second table in a second diagram by using the information regarding the relationship between the first table and the second table.

9. The system of claim 6, wherein the input information further includes a search condition used to search for data that is to be output by the selected type of diagram according to search data,
wherein the output objects further include search objects used to input the search data, and the output objects search for the data that is to be output by the selected type of diagram by using the search data that is input in the search objects and the search condition, and present the found data as the selected type of diagram by using the diagram selection information and the established details.

10. A computer-readable storage medium storing a computer program for creating a report by using objects, the program comprising executable instructions that cause a computer to:
receive input information including a first table that includes first data to be output from among a plurality of tables stored in a database and properties of the first data;
generate a query language sentence used to extract the first data from the first table according to the input information;
extract the first data from the first table using the query language sentence;
receive diagram selection information used to select a type of diagram for presenting the extracted first data;
establish details of the selected type of diagram;
generate output objects to present the extracted first data as the selected type of diagram by using the diagram selection information and the established details;
designate locations for the output objects in a report; and
generate a report screen including the output objects arranged in the locations designated in the report.

11. The computer-readable storage medium of claim 10, further comprising executable instructions that cause a computer to:
generate a portal screen including menus, each menu having a plurality of items,
wherein, when one of the menus is selected, the plurality of items of the selected menu is displayed on the portal screen, and
when one item of the displayed items is selected, the report screen is displayed.

12. The computer-readable storage medium of claim 10, wherein the first data includes upper material values,
wherein the database additionally stores a second table including lower material values that comprise detailed information regarding the upper material values,
the input information further includes information regarding the relationship between the first table and the second table, and if the upper material values included in the first data that is presented as the selected type of diagram are selected, the output objects call and output lower output objects that output the lower material values of the second table in a second diagram by using the information regarding the relationship between the first table and the second table.

13. The computer-readable storage medium of claim 10, wherein the input information further comprises
a search condition used to search for data that is to be output by the selected type of diagram according to search data,
wherein the output objects further comprise search objects used to input the search data, and the output objects search for the data that is to be output by the selected type of diagram by using the search data that is input in the search objects and the search condition, and present the found data as the selected type of diagram by using the diagram selection information and the established detail.
